(19) United States
(12) Patent Application Publication
(10) Pub. No.: US 2026/0007971 A1
(43) Pub. Date: Jan. 8, 2026

(54) METHOD AND APPARATUS FOR DETERMINING TACTICS IN VIRTUAL SCENE, DEVICE, MEDIUM, AND PRODUCT

(71) Applicant: Tencent Technology (Shenzhen) Company Limited, Shenzhen (CN)

(72) Inventor: Tao WANG, Shenzhen (CN)

(21) Appl. No.: 19/324,048

(22) Filed: Sep. 9, 2025

Related U.S. Application Data
(63) Continuation of application No. PCT/CN2024/106216, filed on Jul. 18, 2024.

(30) Foreign Application Priority Data
Sep. 21, 2023 (CN) 202311230833.2

(51) Int. Cl. A63F 13/55; G06T 13/40

(52) U.S. Cl. CPC A63F 13/55; G06T 13/40

(57) ABSTRACT

A method for determining tactics in a virtual scene is performed by a computer device. The method includes: displaying a plurality of associated virtual objects and a plurality of battling virtual objects in a virtual scene; automatically selecting a first tactic mode in response to receiving an automatic tactic selection operation by a user of the computer device; displaying tactic prompt information corresponding to the first tactic mode, the tactic prompt information being configured for prompting the plurality of associated virtual objects to perform a reference battle action corresponding to the first tactic mode based on a layout rule indicating positioning of the plurality of associated virtual objects in the virtual scene associated with the first tactic mode; and generating a tactic execution animation, the tactic execution animation comprising an animation in which the plurality of associated virtual objects perform the reference battle action.

### CROSS-REFERENCE TO RELATED APPLICATIONS

This application is a continuation application of PCT Patent Application No. PCT/CN2024/106216, entitled “METHOD AND APPARATUS FOR DETERMINING TACTICS IN VIRTUAL SCENE, DEVICE, MEDIUM, AND PRODUCT” filed on Jul. 18, 2024, which claims priority to Chinese Patent Application No. 202311230833.2, entitled “METHOD AND APPARATUS FOR DETERMINING TACTICS IN VIRTUAL SCENE, DEVICE, MEDIUM, AND PRODUCT” filed on Sep. 21, 2023, both of which are incorporated herein by reference in their entirety.

### FIELD OF THE TECHNOLOGY

This application relates to the field of computer technologies, and in particular, to a method and apparatus for determining tactics in a virtual scene, a device, a medium, and a product.

### BACKGROUND OF THE DISCLOSURE

Some virtual battles usually involve formation of battle tactics. A user can control a virtual object to battle against an enemy based on a battling tactic. For example, in a basketball sports competition game, when participating in a virtual basketball match, the user needs to determine offensive tactics or defensive tactics based on a current player lineup.

In a related art, in a virtual battle, a plurality of candidate tactics may be displayed. A user may select a proper tactic therefrom. After selecting the tactic, the user needs to control, based on the selected tactic, a virtual object to execute the tactic.

However, the process in which the user selects the tactic and controls the virtual object based on the selected tactic is relatively complex. As a result, the tactic execution efficiency is low. In addition, the execution of the tactic relies on a degree of proficiency of the user with the selected tactic. When the user is not proficient with the selected tactic, a success rate of executing the tactic by the user is low. This further reduces the tactic execution efficiency, thereby reducing human-computer interaction efficiency.

### SUMMARY

Embodiments of this application provide a method and apparatus for determining tactics in a virtual scene, a device, a medium, and a product, which can improve human-computer interaction efficiency. Technical solutions are as follows:

In one aspect, a method for determining tactics in a virtual scene is performed by a computer device and the method including:
displaying a plurality of associated virtual objects and a plurality of battling virtual objects in a virtual scene, the plurality of associated virtual objects being configured for cooperating with each other to conduct a virtual battle against the plurality of battling virtual objects;
automatically selecting a first tactic mode from a plurality of candidate tactic modes in response to receiving an automatic tactic selection operation by a user of the computer device;
displaying tactic prompt information corresponding to the first tactic mode, the tactic prompt information being configured for prompting the plurality of associated virtual objects to perform a reference battle action corresponding to the first tactic mode based on a layout rule indicating positioning of the plurality of associated virtual objects in the virtual scene associated with the first tactic mode; and
generating a tactic execution animation, the tactic execution animation including an animation in which the plurality of associated virtual objects perform the reference battle action.

According to another aspect, a computer device is provided. The computer device includes a processor and a memory. The memory stores at least one instruction, at least one program, a code set, or an instruction set, and the at least one instruction, the at least one program, the code set, or the instruction set, when loaded and executed by the processor, causes the computer device to implement any method for determining the tactics in the virtual scene described above.

In another aspect, a non-transitory computer-readable storage medium is provided. The storage medium stores at least one instruction, at least one program, a code set, or an instruction set. The at least one instruction, the at least one program, the code set, or the instruction set, when loaded and executed by a processor of a computer device, causes the computer device to implement any method for determining the tactics in the virtual scene described above.

In another aspect, a computer program product or a computer program is provided. The computer program product or computer program includes a computer instruction, and the computer-readable instruction is stored in a non-transitory computer-readable storage medium. A processor of a computer device reads the computer instruction from the computer-readable storage medium and executes the computer instruction, causing the computer device to perform any method for determining the tactics in the virtual scene described above.

The technical solutions provided in the embodiments of this application achieve at least the following beneficial effects:

When the computer device receives the automatic tactic selection operation, the computer device displays the tactic prompt information corresponding to the first tactic mode that is automatically determined from the plurality of candidate tactic modes. In one aspect, automatically determining the first tactic mode saves time for a user to make a decision and select a tactic, thereby improving tactic determining efficiency. In another aspect, the tactic prompt information indicates an implementation of the first tactic mode, and a virtual object can be controlled based on the tactic prompt information to perform the reference battle action, to implement the first tactic mode. This explicit guidance reduces tactic execution time, thereby improving tactic execution efficiency. In addition, the tactic prompt information directly designates a specific manner of implementing the first tactic mode, avoids an execution error in a tactic execution process, and increases a tactic execution success rate, thereby improving the tactic execution efficiency and improving human-computer interaction efficiency.

### BRIEF DESCRIPTION OF THE DRAWINGS

FIG. 1 is a schematic diagram of tactic selection according to an exemplary embodiment of this application.

FIG. 2 is a schematic diagram of a computer system according to an exemplary embodiment of this application.

FIG. 3 is a flowchart of a method for determining tactics in a virtual scene according to an exemplary embodiment of this application.

FIG. 4 is a schematic diagram of tactic prompt information according to an exemplary embodiment of this application.

FIG. 5 is a schematic diagram of an automatic tactic determining mode according to an exemplary embodiment of this application.

FIG. 6 is a schematic diagram of a first tactic layout according to an exemplary embodiment of this application.

FIG. 7 is a flowchart of a displaying cancellation method according to an exemplary embodiment of this application.

FIG. 8 is a flowchart of a method for determining a first tactic mode according to an exemplary embodiment of this application.

FIG. 9 is a schematic diagram of a policy using advantage information for different defenses according to an exemplary embodiment of this application.

FIG. 10 is a schematic diagram of a policy using disadvantage information according to an exemplary embodiment of this application.

FIG. 11 is a schematic diagram showing that isolate counteracts infinite switching according to an exemplary embodiment of this application.

FIG. 12 is a schematic diagram showing that perimeter offense counteracts 2-3 zone defense according to an exemplary embodiment of this application.

FIG. 13 is a schematic diagram showing that interior offense counteracts 3-2 zone defense according to an exemplary embodiment of this application.

FIG. 14 is a schematic diagram showing that high screen counteracts interior double-team according to an exemplary embodiment of this application.

FIG. 15 is a flowchart of a method for determining a first tactic mode according to an exemplary embodiment of this application.

FIG. 16 is a schematic flowchart of a method for determining tactics according to an exemplary embodiment of this application.

FIG. 17 is a structural block diagram of an apparatus for determining tactics in a virtual scene according to an exemplary embodiment of this application.

FIG. 18 is a structural block diagram of modules of an apparatus for determining tactics in a virtual scene according to an exemplary embodiment of this application.

FIG. 19 is a structural block diagram of a terminal according to an exemplary embodiment of this application.

### DESCRIPTION OF EMBODIMENTS

Some virtual battles usually involve formation of battle tactics. A user can control a virtual object to battle against an enemy based on a battling tactic. In the related art, schematically, FIG. 1 is a schematic diagram of tactic selection according to an exemplary embodiment of this application. As shown in FIG. 1, a tactic selection user interface (UI) control 110 is displayed in a virtual scene 100. The tactic selection UI control 110 includes a plurality of candidate tactic options. A user needs to manually perform an operation to select a tactic. After a tactic is determined based on a selection operation, a virtual object starts to perform the tactic. After the tactic is selected, the user needs to control, based on the selected tactic, the virtual object to perform the tactic. However, the process in which the user selects the tactic and controls the virtual object based on the selected tactic is relatively complex. As a result, the tactic execution efficiency is low. In addition, the execution of the tactic relies on a degree of proficiency of the user with the selected tactic. When the user is not proficient with the selected tactic, a success rate of executing the tactic by the user is low. This further reduces the tactic execution efficiency, thereby reducing human-computer interaction efficiency.

Based on this, this application provides a method for determining tactics in a virtual scene. When a computer device receives an automatic tactic selection operation, the computer device displays tactic prompt information corresponding to a first tactic mode that is automatically determined from a plurality of candidate tactic modes. In one aspect, automatically determining the first tactic mode saves time for a user to make a decision and select a tactic, thereby improving tactic determining efficiency. In another aspect, the tactic prompt information indicates an implementation of the first tactic mode, and a virtual object can be controlled based on the tactic prompt information to perform the reference battle action, to implement the first tactic mode. This explicit guidance reduces tactic execution time, thereby improving tactic execution efficiency. In addition, the tactic prompt information directly designates a specific manner of implementing the first tactic mode, avoids an execution error in a tactic execution process, and increases a tactic execution success rate, thereby improving the tactic execution efficiency and improving human-computer interaction efficiency.

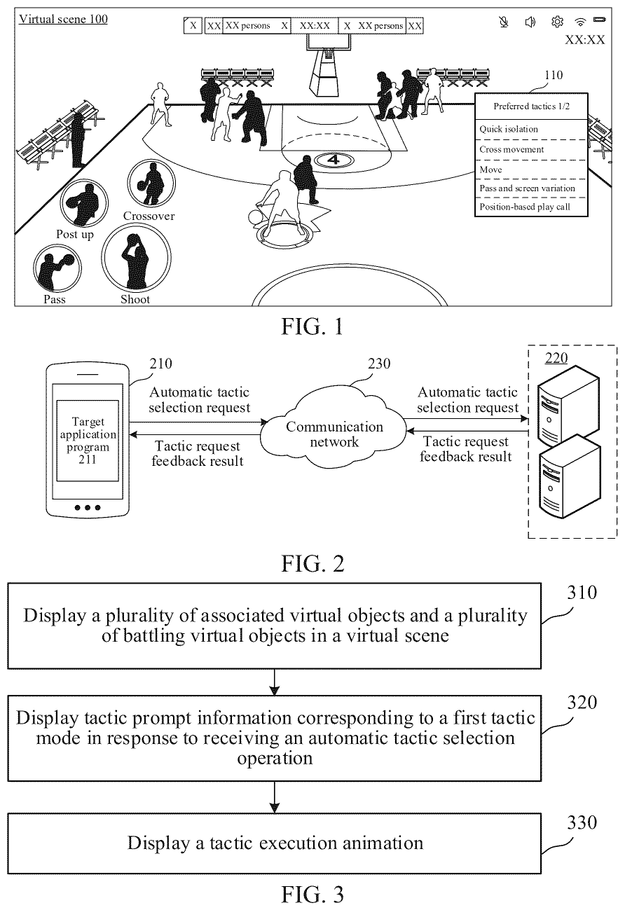

A computer system provided in this application will be described below. FIG. 2 is a schematic diagram of a computer system according to an exemplary embodiment of this application. The computer system includes: a terminal 210, a server 220, and a communication network 230. The terminal 210 and the server 220 are connected through the communication network 230. The communication network 230 is a wired or wireless network.

A target application program 211 is installed and run in the terminal 210. The target application program 211 is an application program that supports a two-dimensional virtual scene or a three-dimensional virtual scene. A virtual scene is a virtual scene displayed (or provided) when an application program is run on a terminal. The virtual scene may be a simulated environment scene for the real world, or may be a semi-simulated and semi-fictitious three-dimensional environment, or may be a purely fictitious three-dimensional environment. The virtual scene may be any one of a two-dimensional virtual scene, a 2.5-dimensional virtual scene, and a three-dimensional virtual scene. The target application program 211 may be any one of a virtual reality application program, an auto chess game, a policy game, a puzzle game, a massive multiplayer online role-playing game (MMORPG), a third-person shooting game (TPS), a first-person shooting game (FPS), a multiplayer online battle arena (MOBA) game, a multiplayer gun fighting survival game, a sports competition game, a simulated training auxiliary application program, a party casual game, and the like. This embodiment of this application is described by using an example in which the target application program 211 is implemented as a sports competition game.

In an implementable manner, the target application program 211 may be a standalone application program, such as a standalone strategic game program, or may be a network-online application program.

In some embodiments, when the target application program 211 is implemented as the standalone application program, the terminal independently performs the above method for determining the tactics in the virtual scene. In some embodiments, when the target application program 211 is implemented as the network-online application program, the server 220 is configured to provide a backend service to the target application program 211 installed in the terminal 210. As shown in FIG. 2, a current target application program 211 is implemented as a sports competition game. A current terminal 210 displays a plurality of associated virtual objects and a plurality of battling virtual objects in a virtual scene. The plurality of associated virtual objects are configured for cooperating with each other for a virtual battle against the plurality of battling virtual objects. When receiving an automatic tactic selection operation, the terminal 210 generates an automatic tactic selection request and transmits the automatic tactic selection request to the server 220. The automatic tactic selection request is configured for requesting the server 220 to automatically select a first tactic mode from a plurality of candidate tactic modes and generate tactic prompt information.

After receiving the automatic tactic selection request, the server 220 automatically selects the first tactic mode from a prestored tactic mode folder based on the automatic tactic selection request, reads tactic data corresponding to the first tactic mode, generates, based on the tactic data, first rendering data for rendering the tactic prompt information and a tactic execution animation, and feeds back the first rendering data as a tactic request feedback result to the terminal 210. After receiving the tactic request feedback result, the terminal 210 performs rendering based on the first rendering data in the tactic request feedback result, to display the tactic prompt information and the tactic execution animation that correspond to the first tactic mode.

The above terminal 210 may be a terminal device in various forms such as a desktop computer, a portable laptop computer, a mobile phone, a tablet computer, an e-book reader, a moving picture experts group audio layer III (MP3) player, a moving picture experts group audio layer IV (MP4) player, a smart television, and a smart vehicle. This is not limited in this embodiment of this application.

In some embodiments, the server 220 is in charge of primary computing work, and the terminal 210 is in charge of secondary computing work. Alternatively, the server 220 is in charge of secondary computing work, and the terminal 210 is in charge of primary computing works. Alternatively, the server 220 and the terminal 210 perform collaborative computation by using a distributed computing architecture. The server 220 may be an independent physical server, a server cluster or a distributed system composed of a plurality of physical servers, or a cloud server, and may alternatively be implemented as a node in a blockchain system.

According to this application, a prompt interface or a pop-up window may be displayed, or voice prompt information may be outputted before and during acquisition of user-related data of a user (for example, virtual battle data, operation data, and account information involved in this application). The prompt interface, the pop-up window, or the voice prompt information is configured for prompting the user that data related to the user is currently being collected, so that this application only starts to perform related operations of obtaining the user-related data after obtaining a confirmation operation of the user for the prompt interface or the pop-up window, otherwise (namely, when the confirmation operation of the user for the prompt interface or the pop-up window is not obtained), ends the related operations of obtaining the user-related data, namely, skips obtaining the user-related data. In other words, all user data acquired in this application is acquired with user consent and authorization, and acquisition, use, and processing of relevant user data need to comply with relevant laws, regulations, and standards of relevant regions.

Schematically, FIG. 3 is a flowchart of a method for determining tactics in a virtual scene according to an exemplary embodiment of this application. The method is performed by a computer device. The computer device may be a terminal or a server, or may be a terminal and a server. This embodiment of this application is described by using an example in which the computer device is implemented as a terminal. As shown in FIG. 3, the method includes the following operations:

Operation 310: Display a plurality of associated virtual objects and a plurality of battling virtual objects in a virtual scene.

The plurality of associated virtual objects are configured for cooperating with each other for a virtual battle against the plurality of battling virtual objects.

The virtual scene is a scene displayed when a target application program installed in the terminal is run, and a first account logs in to the target application program. This embodiment of this application is described by using an example in which the target application program is implemented as a sports competition game.

In some embodiments, the virtual scene is implemented as a competitive sports virtual scene. The competitive sports virtual scene is a scene displayed when a competitive sports game application program installed in the terminal is run. After logging in to the competitive sports game application program, a player may select to start a virtual battle. After the virtual battle is started, the virtual scene corresponding to the virtual battle is displayed on the terminal. Alternatively, the competitive sports virtual scene is a scene displayed when a simulated training auxiliary application program installed in the terminal is run. Exemplarily, a player may input a training parameter (such as a training field type or a training target) to the simulated training auxiliary application program. After the training parameter is determined, the player may select to start virtual training. After a virtual battle is started, the virtual scene corresponding to the virtual training is displayed on the terminal.

Schematically, a virtual scene corresponding to a ball sports competition is used as an example. The competitive sports virtual scene may be at least one of a virtual basketball match (training) scene, a virtual football match (training) scene, a virtual handball match (training) scene, a virtual rugby football match (training) scene, and the like. This is not limited in this embodiment of this application.

The plurality of associated virtual objects in the virtual scene are virtual objects bound to the first account. The plurality of associated virtual objects belong to the same camp in the virtual battle. Schematically, in a virtual basketball match, if the first account belongs to a blue team, five virtual players in the blue team are virtual objects bound to the first account.

In some embodiments, at least one of the plurality of associated virtual objects may be controlled by the first account. A virtual object controlled by the first account among the plurality of associated virtual objects may be referred to as a main control virtual object, and a virtual object not controlled by the first account among the plurality of associated virtual objects may be referred to as a non-main control virtual object. There may be one or more main control virtual objects of the first account. In some embodiments, the main control virtual object of the first account may be fixed. For example, in the virtual battle, the first account may control only one or more fixed virtual objects among the plurality of associated virtual objects. Alternatively, the main control virtual object of the first account is not fixed. For example, in the virtual battle, the first account may switch to select a virtual object from the plurality of associated virtual objects as a main control virtual object in real time. In some embodiments, the main control virtual object among the plurality of associated virtual objects conducts the virtual battle based on an operation of the first account, and the non-main control virtual object among the plurality of associated virtual objects cooperates with the main control virtual object based on a binding relationship to conduct the virtual battle against the plurality of battling virtual objects. In some embodiments, the first account may control the main control virtual object to perform at least one of operations such as moving, performing a specified action, interacting with another virtual object (including at least one of the non-main control virtual object among the plurality of associated virtual objects or a battling virtual object), and completing a specified task in the virtual scene. To be specific, a behavior of the main control virtual object in the virtual scene is completely controlled by the first account.

In some embodiments, the non-main control virtual object and the main control virtual object among the plurality of associated virtual objects have an association relationship, for example, a teammate relationship or a subordinate relationship. When the association relationship is implemented as the teammate relationship, the non-main control virtual object may alternatively be referred to as a teammate virtual object of the main control virtual object. When the association relationship is implemented as the subordinate relationship, the non-main virtual object may alternatively be referred to as a subordinate virtual object of the main control virtual object.

In some embodiments, a non-main control virtual object among the plurality of associated virtual objects includes at least one of a non-player character (NPC) and a virtual object controlled by another account. This is not limited here. Schematically, in a virtual basketball match, if the first account belongs to a blue team, virtual player a among five virtual players in the blue team is a virtual object controlled by the first account (which may be understood as user 1), namely, a main control virtual object, and virtual player b is a virtual object controlled by a second account (which may be understood as user 2), and virtual player c, virtual player d, and virtual player e are virtual objects controlled by a system, namely, non-player characters. Virtual players b, c, d, and e are all non-main control virtual objects.

In some embodiments, the plurality of battling virtual objects and the plurality of associated virtual objects are in opposing camps in the virtual battle.

In some embodiments, the battling virtual objects may be virtual objects operated and controlled by another terminal based on another account, or may be virtual objects automatically controlled by a terminal or a server through artificial intelligence (AI).

A quantity of battling virtual objects may be the same as or different from a quantity of associated virtual objects.

In some embodiments, a virtual object in the virtual scene correspondingly has configuration data. The configuration data is configured for indicating a battling ability of the virtual object in the virtual battle. For example, an associated virtual object correspondingly has first configuration data, and the first configuration data is configured for indicating a battling ability of the associated virtual object in the virtual battle. A battling virtual object correspondingly has second configuration data, and the second configuration data is configured for indicating a battling ability of the battling virtual object in the virtual battle. In some embodiments, the configuration data may be configured for the virtual object in advance by the target application program in the terminal, or may be acquired based on a physical object (such as player A). Schematically, an example in which the virtual scene is implemented as a virtual scene corresponding to a virtual basketball match is used. The configuration data includes data about aspects such as physical fitness, agility, strength, a speed, endurance, and an adept tactic mode of the virtual object. Specifically, the data about the physical fitness may include a height, a weight, an arm span, a body fat rate, and the like.

The above configuration data is only an illustrative example. This is not limited in this application.

Operation 320: Display tactic prompt information corresponding to a first tactic mode in response to receiving an automatic tactic selection operation.

The first tactic mode is a tactic executed when the plurality of associated virtual objects participates in the virtual battle. The first tactic mode indicates the following information: (1) a layout rule of the plurality of associated virtual objects: the layout rule is configured for indicating positioning of the plurality of associated virtual objects in the virtual scene; and (2) an action mode of the plurality of associated virtual objects: the action mode determines a reference battle action that needs to be performed by the plurality of associated virtual objects.

In some embodiments, a plurality of candidate tactic modes are preset tactic modes. A tactic mode in a basketball battle is used as an example. The plurality of candidate tactic modes include, but are not limited to, at least one of an isolate mode, a high screen and roll mode, an interior offense mode, a perimeter offense mode, a 2-3 zone defense mode, a 3-2 zone defense mode, an infinite switching mode, and an interior double-team mode.

The tactic prompt information is configured for prompting the plurality of associated virtual objects to perform the reference battle action corresponding to the first tactic mode based on the layout rule indicated by the first tactic mode. To be specific, the tactic prompt information prompts an implementation of the first tactic mode. A user may control, under the prompt of the tactic prompt information, the plurality of associated virtual objects to implement the first tactic mode.

In some embodiments, the tactic prompt information includes at least one of text information, graphic information, animation information, and the like. For example, text information of “Shoot” may be displayed to prompt an associated virtual object to perform a basketball shooting action. Graphic information pointing to a target position may be displayed to prompt an associated virtual object to perform a movement action to move to the target position. A demonstration animation for defending against an opposing player may be displayed to prompt an associated virtual object to perform a defensive action to defend against an opposing player. The demonstration animation may be implemented as an animation effect in which a demonstration object that is the same as the associated virtual object performs the defensive action. This is not limited in this embodiment of this application.

The automatic tactic selection operation is configured for automatically selecting the first tactic mode from the plurality of candidate tactic modes. Schematically, the automatic tactic selection operation is configured for enabling an automatic tactic determining mode. The automatic tactic determining mode is configured for automatically selecting the first tactic mode from the plurality of candidate tactic modes.

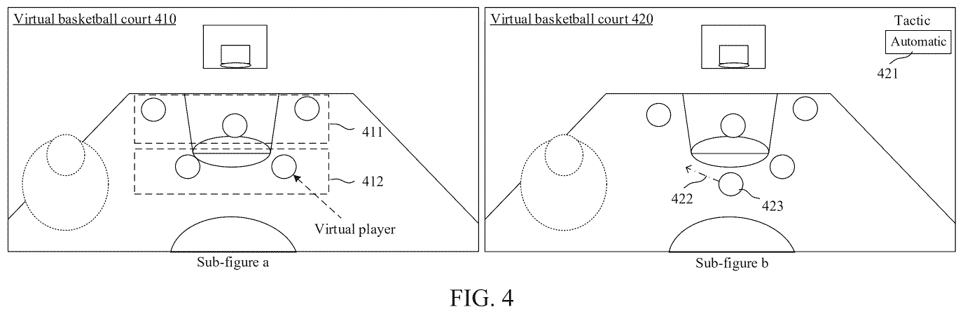

Schematically, an example in which the virtual scene is implemented as a virtual basketball court is used. The battling virtual objects and the associated virtual objects conduct a basketball battle. The plurality of associated virtual objects are implemented as virtual players bound to the first account, and the plurality of battling virtual objects are implemented as virtual players opponent to the first account. Referring to FIG. 4, sub-figure a shows positioning in a 2-3 zone defense mode. A virtual basketball court 410 includes an upper region 411 and a lower region 412. Two virtual players in the upper region 411 stand at two endpoints of a free throw line in the virtual basketball court 410, and two virtual players at a perimeter of the lower region 412 are within a three-point line for defense. A virtual player in the middle of the lower region 412 is within a three-point line region to grab a rebound.

It is assumed that the first tactic mode is implemented as the 2-3 zone defense mode. As shown in sub-figure b in FIG. 4, a control 421 is tapped to enable the automatic tactic determining mode to automatically select the 2-3 zone defense mode from the plurality of preset candidate tactic modes as the first tactic mode. Tactic prompt information (i.e. an arrow) 422 corresponding to the 2-3 zone defense mode is displayed on the virtual basketball court 420. The tactic prompt information 422 is configured for prompting a virtual player 423 to move to a position indicated by the tactic prompt information 422, so that positioning of the virtual player 423 and positioning of other virtual players can satisfy the positioning of the 2-3 zone defense mode shown in sub-figure a in FIG. 4.

In some embodiments, in the first tactic mode, when a first virtual object among the plurality of associated virtual objects satisfies an execution condition of a first reference battle action, first tactic prompt information corresponding to the first reference battle action is displayed, the first tactic prompt information being configured for prompting the first virtual object to perform the first reference battle action. There may be one or more first virtual objects that satisfy the execution condition of the first reference battle action.

Schematically, that the first virtual object satisfies the execution condition of the first reference battle action indicates that the first virtual object needs to perform the first reference battle action in the first tactic mode. For example, when the first tactic mode is implemented as the 2-3 zone defense mode, and a ball-handler is open, it indicates that the ball-handler satisfies an execution condition corresponding to a basketball shooting action in a finish move, and tactic prompt information corresponding to the basketball shooting action is displayed. The tactic prompt information is configured for prompting the ball-handler to perform the basketball shooting action. That the ball-handler is open means that the ball-handler is in a position at which there is no or almost no interference from a defensive player when the ball-handler is on offense.

In the above embodiment, the tactic prompt information is prompt information displayed for the first virtual object that satisfies the execution condition of the reference battle action among the plurality of associated virtual objects. To be specific, the tactic prompt information directly points to an eligible virtual object, to help a user identify a virtual object needing to perform the reference battle action, thereby improving accuracy of the tactic prompt information. When the user needs to execute a tactic based on the tactic prompt information, a misoperation caused by unclear information can be avoided, and tactic execution accuracy and efficiency can be improved. An example in which the virtual scene is a virtual scene corresponding to a ball sports competition is used for description. In some embodiments, the reference battle action includes at least one of a movement action, a shooting action, a tactical offense action, a tactical defense action, and the like. The movement action is an action of movement of an associated virtual object in the virtual scene. The shooting action is an action of throwing a virtual ball prop toward a shooting target, and the shooting target includes a virtual ball hoop or another virtual object. The tactical offense action includes, but is not limited to, screen, post-up, drive, dribble, and the like. The tactical defense action includes, but is not limited to, close-up, block, steal, help defense, double-team, switch, zone defense, and the like.

An example in which the reference battle action includes the movement action and the shooting action is used for description. The case in which the first virtual object among the plurality of associated virtual objects satisfies the execution condition of the first reference battle action includes at least one of the following cases:

Case I: in the first tactic mode, display movement prompt information when the first virtual object among the plurality of associated virtual objects satisfies an execution condition of the movement action, the movement prompt information being configured for prompting the first virtual object to move toward a first position in the virtual scene. Schematically, current positioning of the plurality of associated virtual objects satisfies a layout rule indicated by an infinite switching mode. After the automatic tactic determining mode is enabled, it is determined that the first tactic mode (i.e. a tactic mode that needs to be executed currently) is the 2-3 zone defense mode. Assuming that the first virtual object among the plurality of associated virtual objects needs to move, to cause the positioning of the plurality of associated virtual objects to satisfy the layout rule indicated by the 2-3 zone defense mode, it indicates that the first virtual object satisfies the execution condition of the movement action, and the movement prompt information corresponding to the first virtual object may be displayed to prompt the first virtual object to move. Alternatively, that the first virtual object among the plurality of associated virtual objects satisfies an execution condition corresponding to the defense action indicates that the first virtual object needs to defend against a second virtual object among the battling virtual objects, but the first virtual object needs to move to a defense position before defending. In this case, the first virtual object satisfies the execution condition of the movement action, and the movement prompt information may be displayed to prompt the first virtual object to move toward the defense position.

In the above embodiment, the scheme for displaying the movement prompt information is provided. After the automatic tactic selection operation is triggered, the movement prompt information may be displayed on an interface of the terminal, to prompt the eligible virtual object to perform the movement action. In a competitive game, accurate movement is a key of whether a tactic is successfully executed. The introduction of the movement prompt information enables a user to more accurately control actions of a virtual object during competition, thereby improving a tactic execution success rate.

In some embodiments, the movement prompt information includes at least one of the following information: (1) positioning prompt information, the positioning prompt information being configured for indicating a first position; and (2) a movement path, the movement path being configured for indicating a movement path of the first virtual object moving to the first position. Specific content of the movement prompt information is not limited in this embodiment of this application. For example, the movement prompt information may further include text for prompting shooting.

In some embodiments, the first virtual object includes a ball-handling virtual object. In some embodiments, when the ball-handling virtual object satisfies the execution condition of the movement action, the positioning prompt information is displayed. The positioning prompt information is configured for indicating a position at which the ball-handling virtual object needs to arrive after moving according to the first tactic mode.

Schematically, the position at which the ball-handling virtual object needs to arrive after moving according to the first tactic mode may be a shooting position, and the case in which the ball-handling virtual object satisfies the execution condition of the movement action may alternatively be: the ball-handling virtual object among the plurality of associated virtual objects satisfies the execution condition corresponding to the shooting action, but the first virtual object needs to move to the shooting position before throwing. In this case, the positioning prompt information may be displayed to prompt the first virtual object to move toward the shooting position.

Case II: display shooting prompt information when the first virtual object includes a ball-handling virtual object and the ball-handling virtual object satisfies an execution condition of the shooting action, the shooting prompt information being configured for prompting the ball-handling virtual object to throw a virtual ball prop toward a shooting target, and the shooting target including a virtual ball hoop or another virtual object.

In some embodiments, the shooting prompt information includes a shooting path, and the shooting path is configured for indicating a throwing path that the ball-handling virtual object throws the virtual ball prop toward the shooting target. Specific content of the shooting prompt information is not limited in this embodiment of this application. For example, the shooting prompt information may further include text for prompting shooting.

Schematically, that the ball-handling virtual object among the plurality of associated virtual objects satisfies the execution condition corresponding to the shooting action indicates that the first virtual object needs to throw a ball, and the shooting prompt information is displayed to prompt the ball-handling virtual object to throw the virtual ball prop toward the shooting target. If the shooting target is the virtual ball hoop, it indicates that the shooting action is a basketball shooting action or a football shooting action. If the shooting target is the another virtual object, it indicates that the shooting action is a passing action.

In the above embodiment, the scheme for displaying the shooting prompt information is provided. After the automatic tactic selection operation is triggered, the shooting prompt information may be displayed on the interface of the terminal, to prompt the eligible virtual object to perform a shooting action. In a competitive game, the shooting action is a key to achieving a battle victory. The introduction of the shooting prompt information helps a user quickly identify an optimal shooting occasion, thereby reducing hesitation and misjudgment of the user at key moments and improving a tactic execution success rate and a battle winning rate.

In some embodiments, the first tactic mode corresponds to a plurality of tactic execution stages, and the tactic prompt information is sequentially displayed based on the plurality of tactic execution stages. If an associated virtual object automatically executes the first tactic mode after the first tactic mode is determined, in response to receiving the automatic tactic selection operation, tactic prompt information of a 1^{st} tactic execution stage is displayed. After the associated virtual object automatically completes the 1^{st} tactic execution stage, tactic prompt information of a 2^{nd} tactic execution stage is displayed. The rest can be deduced by analogy, until the plurality of tactic execution stages of the first tactic mode are automatically completed, or the first tactic mode is interrupted. If an associated virtual object executes the first tactic mode based on an operation of the first account after the first tactic mode is determined, in response to receiving the automatic tactic selection operation, tactic prompt information of a 1^{st} tactic execution stage is displayed. After the associated virtual object controlled based on the operation of the first account completes the 1^{st} tactic execution stage, tactic prompt information of a 2^{nd} tactic execution stage is displayed. The rest can be deduced by analogy, until the plurality of tactic execution stages of the first tactic mode are completed based on the operation of the first account, or the first tactic mode is interrupted.

In some embodiments, when the terminal receives the automatic tactic selection operation, the terminal enables the automatic tactic determining mode, and automatically selects the first tactic mode from the plurality of preset candidate tactic modes based on AI.

In some embodiments, by the automatic tactic determining mode, the first tactic mode may be automatically selected based on a configuration situation and/or a tactic counteraction situation of a virtual object. The configuration situation of the virtual object includes an advantage situation of an associated virtual object and a disadvantage situation of a battling virtual object.

In some embodiments, after the terminal enables the automatic tactic determining mode, the terminal determines the first tactic mode based on current virtual battle data in the virtual scene, and generates the tactic prompt information.

The virtual battle data includes, but is not limited to, first configuration data corresponding to the associated virtual objects, second configuration data corresponding to the battling virtual objects, current positioning layout data in the virtual scene, and preset tactic counteraction information. The first configuration data is configured for indicating a battling ability of the associated virtual objects in the virtual battle. The second configuration data is configured for indicating a battling ability of the associated virtual objects in the virtual battle. The positioning layout data is configured for indicating a positioning layout of the associated virtual objects and the battling virtual objects in a current virtual scene, and the tactic counteraction information is configured for indicating counteraction relationships between the plurality of candidate tactic modes.

In some embodiments, by the automatic tactic determining mode, the first tactic mode may be determined based on at least one of the advantage situation of the associated virtual objects, the disadvantage situation of the battling virtual objects, and the tactic counteraction situation. The determining the first tactic mode based on the advantage case of the associated virtual objects may be implemented as: determining the first tactic mode based on the first configuration data and the positioning layout data. The determining the first tactic mode based on the disadvantage situation of the battling virtual objects may be implemented as: determining the first tactic mode based on the second configuration data and the positioning layout data. The determining the first tactic mode based on the tactic counteraction situation may be implemented as: determining the first tactic mode based on the positioning layout data and the tactic counteraction information.

In an actual automatic tactic determining process, a manner of determining a tactic may be adjusted in real time based on different situations. For example, the tactic is adjusted in real time if priorities of the first configuration data, the second configuration data, and the tactic counteraction information satisfy an arrangement relationship from high to low. For example, the automatic tactic determining mode first determines the first tactic mode based on the positioning layout data and the advantage information indicated by the first configuration data; if the first tactic mode determined based on the advantage situation of the associated virtual objects fails, determines the first tactic mode based on the positioning layout data and the disadvantage information indicated by the second configuration data; and if the first tactic mode determined based on the disadvantage situation of the battling virtual objects also fails, determines the first tactic mode based on the positioning layout data and the tactic counteraction information.

Operation 330: Display a tactic execution animation.

The tactic execution animation includes an animation in which the plurality of associated virtual objects perform the reference battle action.

In some embodiments, the tactic execution animation may be rendered and displayed by the terminal by generating rendering data in advance based on a case that the associated virtual objects automatically execute the first tactic mode, or may be rendered and displayed by the terminal by generating rendering data in real time based on operation data of the first account.

In some embodiments, the automatic tactic selection operation includes a fully automatic tactic selection operation and a semi-automatic tactic selection operation. In some embodiments, operation 330 includes the following two cases:

First case: automatically display the tactic execution animation when the fully automatic tactic selection operation is received.

The fully automatic tactic selection operation is configured for: automatically determining the first tactic mode and controlling the plurality of associated virtual objects to automatically perform the reference battle action.

Schematically, after the fully automatic tactic selection operation is triggered, a fully automatic tactic determining mode is enabled. The fully automatic tactic determining mode is configured for: automatically determining the first tactic mode and instructing the plurality of associated virtual objects to automatically perform the reference battle action to implement the first tactic mode. When the tactic execution animation is displayed based on the fully automatic tactic determining mode, the tactic execution animation may be rendered and displayed by the terminal by generating the rendering data in advance based on the case that the associated virtual objects automatically execute the first tactic mode.

In the above embodiment, after the fully automatic tactic selection operation is triggered, the reference battle action is automatically performed by a computer device, so that a user does not need to perform an extra operation, thereby improving tactic execution efficiency. Meanwhile, the user can learn about a tactic execution manner according to the tactic prompt information, thereby enhancing a sense of participation into the battle of the user and helping the user become proficient with the first tactic mode.

Second case: display, when a semi-automatic tactic selection operation is received, the tactic execution animation in response to receiving a tactic execution operation on the plurality of associated virtual objects.

The semi-automatic tactic selection operation is configured for: automatically determining the first tactic mode and performing the reference battle action in response to the tactic execution operation.

Schematically, the semi-automatic tactic selection operation is configured for enabling a semi-automatic tactic determining mode. The semi-automatic tactic determining mode is configured for: automatically determining the first tactic mode and executing the first tactic mode based on an operation of the first account. When the tactic execution animation is displayed based on the semi-automatic tactic determining mode, the tactic execution animation may be rendered and displayed by the terminal by generating rendering data in real time based on operation data of the first account.

In the above embodiment, after the semi-automatic tactic selection operation is triggered, the reference battle action is manually performed by a user. The tactic prompt information may assist the user in performing the reference battle action, thereby reducing tactic execution errors caused by an operation error of the user and improving a tactic execution success rate. Thus, tactic execution efficiency is improved, and human-computer interaction efficiency is improved.

In some embodiments, a control may be displayed on the terminal interface to trigger the automatic tactic selection operation.

In some embodiments, a first control is displayed when the first account does not meet a proficiency requirement, the first control being configured for triggering the fully automatic tactic selection operation; and the first control and a second control are displayed when the first account meets the proficiency requirement, the second control being configured for triggering the semi-automatic tactic selection operation.

In some embodiments, that the first account meets the proficiency requirement may be implemented as: a battling proficiency of the first account is greater than or equal to a preset proficiency. That the first account does not meet the proficiency requirement may be implemented as: the battling proficiency of the first account is less than the preset proficiency. The battling proficiency may be determined based on at least one of the following information: (1) a number of instances of participation in the virtual battle, where schematically, a larger number of instances of participation of the first account in a virtual basketball match in a basketball competitive game reflects a higher battling proficiency; (2) a winning rate of participation in the virtual battle, where schematically, a larger winning rate of the virtual basketball match in which the first account participates in the basketball competitive game reflects a higher battling proficiency; and (3) scores of participation in the virtual battle, where schematically, a higher score of each part of the virtual basketball match in which the first account participates in the basketball competitive game indicates a higher battling proficiency.

The above examples of determining the information about the battling proficiency are merely for exemplary description, and are not limited in this embodiment of this application. For example, for a basketball competitive game, a first account that can stably contribute to rebound and steal has a high battling proficiency; a first account that has fewer fouls and turnovers has a higher battling proficiency; and the like.

Schematically, when the battling proficiency of the first account is less than the preset proficiency, the first control may be displayed on the terminal interface, and the first control is designed to trigger the fully automatic tactic selection operation. The fully automatic tactic selection operation means that the target application program may completely take over decision-making and execution processes of a tactic, automatically determine the most appropriate tactic mode, and control the plurality of associated virtual objects to automatically perform a series of preset reference battle actions or a series of reference battle actions adjusted based on a real-time situation. This manner reduces an operation burden of a new hand or a user wishing to quickly complete a task. When the battling proficiency of the first account is less than the preset proficiency, the second control may be additionally displayed on the terminal interface. The function of the first control keeps unchanged, namely, the fully automatic tactic selection operation is triggered. The second control is configured for triggering the semi-automatic tactic selection operation. Under the semi-automatic tactic selection operation, the target application program may still automatically determine the first tactic mode. However, a difference lies in that a player needs to trigger, by performing the tactic execution operation, the virtual objects to perform the reference battle action. This manner gives a user more control.

In the above embodiment, by dynamically adjusting an interface control based on the proficiency of a user, the target application program can better adapt to user requirements at different levels, thereby enhancing an overall user experience. For new hands, the fully automatic mode helps the new hands quickly become proficient with a game mechanism and a tactic layout. As the proficiency increases, the semi-automatic mode encourages the new hands to actively participate in tactic execution, to promote skill development. In addition, when the new hands have low proficiency, only a trigger control of the fully automatic tactic selection operation is provided, which can greatly lower an operation difficulty of the new hands and reduce mistakes caused by being not proficient with operations. This not only protects enthusiasms and confidence of the new hands, but also avoids a waste of resources and time caused by misoperations.

In conclusion, according to the method provided in this embodiment of this application, when the computer device receives the automatic tactic selection operation, the computer device displays the tactic prompt information corresponding to the first tactic mode that is automatically determined from the plurality of candidate tactic modes. In one aspect, automatically determining the first tactic mode saves time for a user to make a decision and select a tactic, thereby improving tactic determining efficiency. In another aspect, the tactic prompt information indicates an implementation of the first tactic mode, and a virtual object can be controlled based on the tactic prompt information to perform the reference battle action, to implement the first tactic mode. This explicit guidance reduces tactic execution time, thereby improving tactic execution efficiency. In addition, the tactic prompt information directly designates a specific manner of implementing the first tactic mode, avoids an execution error in a tactic execution process, and increases a tactic execution success rate, thereby improving the tactic execution efficiency and improving human-computer interaction efficiency.

In some embodiments, the automatic tactic selection operation in operation 320 includes a fully automatic tactic selection operation and a semi-automatic tactic selection operation. In some embodiments, the first tactic mode corresponds to a plurality of tactic execution stages, and the tactic prompt information is sequentially displayed based on the plurality of tactic execution stages. Schematically, in response to receiving the fully automatic tactic selection operation, tactic prompt information of a 1^{st} tactic execution stage is displayed. After the associated virtual object automatically completes the 1^{st} tactic execution stage, tactic prompt information of a 2^{nd} tactic execution stage is displayed. The rest can be deduced by analogy, until the plurality of tactic execution stages of the first tactic mode are automatically completed, or the first tactic mode is interrupted.

Schematically, in response to receiving the semi-automatic tactic selection operation, tactic prompt information of a 1^{st} tactic execution stage is displayed. After the associated virtual object controlled based on the operation of the first account completes the 1^{st} tactic execution stage, tactic prompt information of a 2^{nd} tactic execution stage is displayed. The rest can be deduced by analogy, until the plurality of tactic execution stages of the first tactic mode are completed based on the operation of the first account, or the first tactic mode is interrupted.

In some embodiments, the automatic tactic selection operation is received through a UI control.

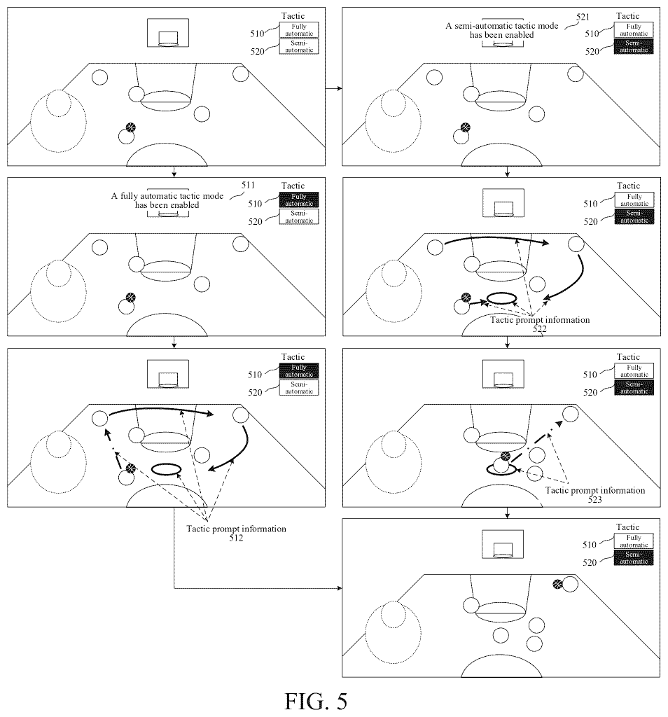

Schematically, FIG. 5 is a schematic diagram of an automatic tactic determining mode according to an exemplary embodiment of this application. As shown in FIG. 5, a virtual scene includes a fully automatic UI control 510 and a semi-automatic UI control 520. The fully automatic UI control 510 is configured for receiving a fully automatic tactic selection operation, and the semi-automatic UI control 520 is configured for receiving a semi-automatic tactic selection operation. In response to receiving a trigger operation on the fully automatic UI control 510, a fully automatic tactic determining mode enable prompt 511 is displayed, and tactic prompt information 512 corresponding to each tactic execution stage is always automatically displayed, until a plurality of tactic execution stages of a first tactic mode are automatically executed, or the first tactic mode is interrupted. The fully automatic tactic determining mode enable prompt 511 is configured for prompting a user that a fully automatic tactic mode has been already enabled, and an associated virtual object will automatically execute the first tactic mode based on the tactic prompt information. The user does not need to perform an operation to execute the first tactic mode. In response to receiving a trigger operation on the semi-automatic UI control 520, a semi-automatic tactic determining mode enable prompt 521 is displayed, and tactic prompt information 522 of a 1^{st} tactic execution stage is displayed. After the associated virtual object controlled based on the operation of the first account completes the 1^{st} tactic execution stage, tactic prompt information 523 of a 2^{nd} tactic execution stage is displayed. The rest can be deduced by analogy, until a plurality of tactic execution stages of a first tactic mode are completed based on an operation of a first account, or the first tactic mode is interrupted. The semi-automatic tactic determining mode enable prompt 521 is configured for prompting a user that a semi-automatic tactic mode has been already enabled, and an operation needs to be performed based on the tactic prompt information.

In some embodiments, in operation 320, the movement path in the tactic prompt information may be implemented as a solid curve with an arrow; the positioning prompt information may be implemented as a hollow ellipse; and the shooting path may be implemented as a dashed curve with an arrow.

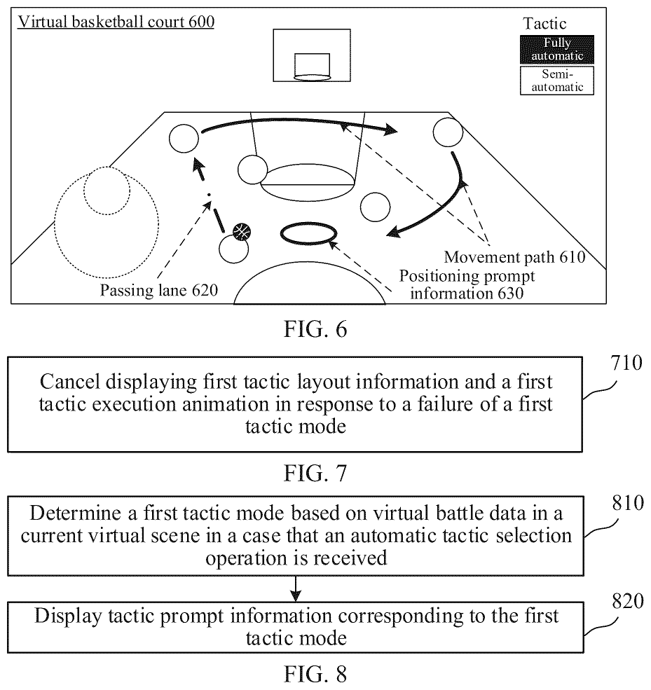

Schematically, FIG. 6 is a schematic diagram of tactic prompt information according to an exemplary embodiment of this application. As shown in FIG. 6, in a virtual basketball court 600, a first tactic mode is determined based on an automatic tactic selection operation. A movement path 610 is displayed when an associated virtual object needs to pass the ball. A passing lane 620 is displayed when a ball-handling virtual object needs to pass the ball. Positioning prompt information 630 is displayed when the ball-handling virtual object needs to move.

In some embodiments, after operation 330, the method further includes a displaying cancellation process for the tactic prompt information and the tactic execution animation. FIG. 7 is a flowchart of a displaying cancellation method according to an exemplary embodiment of this application. The method may be performed by a terminal, or by a server, or by both a terminal and a server. This embodiment of this application is described by using an example in which the method is performed by the terminal. As shown in FIG. 7, the method includes the following operations:

Operation 710: Cancel displaying the tactic prompt information and the tactic execution animation in response to a failure of the first tactic mode.

In some embodiments, the failure of the first tactic mode includes execution of the first tactic mode is completed, or the first tactic mode is interrupted by a battling virtual object, or an associated virtual object makes a mistake in execution of the first tactic mode, or the like.

An example in which a virtual scene is a virtual scene corresponding to a ball sports competition is used. A virtual object is configured for participating in a ball sports competition battle. In some embodiments, the failure of the first tactic mode includes at least one of the following cases:

In a first case, the execution of the first tactic mode is completed.

In some embodiments, after the execution of the first tactic mode is completed, the first tactic mode is re-determined based on current virtual battle data.

In a second case, a virtual object waiting for movement does not move based on movement prompt information during movement.

In some embodiments, that the virtual object waiting for movement does not move based on the movement prompt information during movement includes: the virtual object waiting for movement does not move based on a movement path indicated by the movement prompt information; the virtual object waiting for movement does not arrive at a first position (i.e. a movement end position) indicated by the movement prompt information after moving; the virtual object waiting for movement does not start to move within a preset duration range; and the like.

When the associated virtual object is implemented as a shooting virtual object, the first position may be a shooting position. Schematically, when a ball-handling virtual object takes a shot, the ball-handling virtual object needs to move to the shooting position, and that the shooting virtual object does not move based on the movement prompt information during the movement further includes: the ball-handling virtual object does not arrive at the shooting position within the preset duration range.

In a third case, when the ball-handling virtual object throws a virtual ball prop toward a shooting target, the ball-handling virtual object fails in throwing.

In some embodiments, when the ball-handling virtual object throws the virtual ball prop toward the shooting target, the ball-handling virtual object fails in throwing, which includes: the virtual ball prop thrown by the ball-handling virtual object is blocked by the associated virtual object; another virtual object drops pass; the ball-handling virtual object does not throw the virtual ball prop within a preset duration range; or the like.

In conclusion, according to the method provided in this embodiment of this application, when the first tactic mode fails, the tactic prompt information and the tactic execution animation are canceled being displayed, thereby reducing computer resource consumption. Meanwhile, when the first tactic mode fails, the tactic prompt information and the tactic execution animation are canceled being displayed in time, so that an impact of a display element in the virtual scene on observation of a real-time virtual battle by a user can be reduced, thereby improving human-computer interaction efficiency.

In some embodiments, operation 320 includes a determining process of the first tactic mode. FIG. 8 shows a flowchart of a method for determining a first tactic mode according to an exemplary embodiment of this application. The method may be performed by a terminal, or by a server, or by both a terminal and a server. This embodiment of this application is described by using an example in which the method is performed by the terminal. As shown in FIG. 8, operation 320 includes the following operations:

Operation 810: Determine the first tactic mode based on virtual battle data in the current virtual scene when the automatic tactic selection operation is received.

In some embodiments, the automatic tactic selection operation includes a fully automatic tactic selection operation and a semi-automatic tactic selection operation.

In some embodiments, the automatic tactic selection operation is received through a UI control in the virtual scene. In some embodiments, the automatic tactic selection operation may alternatively be received in a manner of performing a slide operation on an interface of the terminal that displays the virtual scene, performing a shake operation on the terminal that displays the virtual scene. The description of the above manner of receiving the automatic tactic selection operation is only an illustrative example. This is not limited in this application.

In some embodiments, the virtual battle data includes at least one of positioning layout data, configuration data of the virtual objects, and tactic counteraction information.

The virtual battle data includes the positioning layout data, and the positioning layout data is configured for indicating a positioning layout of the associated virtual objects and the battling virtual objects in the virtual scene. In some embodiments, the positioning layout data includes positioning layout information of the associated virtual objects, positioning layout information of the battling virtual objects, and tactic categories that the positioning layout information may satisfy.

Schematically, a virtual basketball court includes an upper region and a lower region. Two of the plurality of associated virtual objects are in the upper region, separately standing at two endpoints of a free throw line in the virtual basketball court. Two associated virtual objects are in a perimeter of the lower region and are within a three-point line for defense. One associated virtual object is in a middle position of the lower region and is within a three-point line region for defense to grab a rebound. The current positioning layout of the associated virtual objects satisfies a 2-3 zone defense mode.

In some embodiments, a positioning layout corresponding to a tactic mode similar to the current positioning layout is determined based on the positioning layout data.

Configuration information of a virtual object is configured for indicate a battling ability of the virtual object in a virtual battle. In some embodiments, the configuration information is determined based on preset configuration data. The configuration data may be configured in advance for the virtual object by the target application program in the terminal, or may be acquired based on an actual human body object.

In some embodiments, the configuration information of the virtual object includes at least one of first configuration information of an associated virtual object and second configuration information of a battling virtual object.

The first configuration data is configured for indicating a battling ability of the associated virtual object in the virtual battle. Schematically, an example in which the virtual scene is implemented as a virtual scene corresponding to a virtual basketball sports competition is used. The first configuration data includes data about aspects such as physical fitness, agility, strength, a speed, endurance, and an adept tactic mode category of the associated virtual object. Specifically, the data about the physical fitness may include a height, a weight, an arm span, a body fat rate, and the like.

In some embodiments, advantage information of the associated virtual object is determined based on the first configuration data. For example, that associated virtual object A having a large height, a long arm span, and a good leaping ability is suitable for blocking belongs to advantage information of the associated virtual object in the aspect of blocking.

The second configuration data is configured for indicating a battling ability of the battling virtual object in the virtual battle. Schematically, an example in which the virtual scene is implemented as a virtual scene corresponding to a virtual basketball sports competition is used. The second configuration data includes data about aspects such as physical fitness, agility, strength, a speed, endurance, and an adept tactic mode category of the battling virtual object. Specifically, the data about the physical fitness may include a height, a weight, an arm span, a body fat rate, and the like.

In some embodiments, disadvantage information of the battling virtual object is determined based on the second configuration data. For example, that battling virtual object B having a small height, a light weight, and poor strength is not suitable for posting up belongs to disadvantage information of the battling virtual object in the aspect of posting up.

The tactic counteraction information is configured for indicating counteraction relationships between the plurality of candidate tactic modes.

Schematically, a tactic in a basketball battle is used as an example. The plurality of candidate tactic modes include an offensive tactic mode and a defensive tactic mode. The offensive tactic mode includes, but is not limited to, an isolate mode, a high screen and roll mode, an interior offense mode, and a perimeter offense mode, and the defensive tactic mode includes, but is not limited to, a 2-3 zone defense mode, a 3-2 zone defense mode, an infinite switching mode, and an interior double-team mode. A counteraction relationship between the offensive tactic mode and the defensive tactic mode is used as an example. The tactic counteraction information is configured for indicating various counteraction relationships, such as a counteraction relationship between the isolate mode and the infinite switching mode, a counteraction relationship between the perimeter offense mode and the 3-2 zone defense mode, a counteraction relationship between the interior offense mode and the 2-3 zone defense mode, and a counteraction relationship between the high screen mode and the interior double-team mode.

In some embodiments, the determining the first tactic mode based on virtual battle data in the current virtual scene includes at least one of the following cases.

(1) The first tactic mode is automatically determined based on the positioning layout data and the advantage information indicated by the first configuration data.

In some embodiments, the terminal determines the advantage information by comparing the first configuration data with the second configuration data, and determines, from the plurality of candidate tactic modes based on the positioning layout data and the advantage information, a tactic mode in which the associated virtual objects have maximized advantages as the first tactic mode.

Schematically, it is assumed that the associated virtual objects use the perimeter offense mode to counteract the 2-3 zone defense mode of the battling virtual objects, but the plurality of associated virtual objects cannot well complete the perimeter offense mode because of their lower perimeter offense abilities. Therefore, by considering the advantage information of the associated virtual objects, a policy in which the advantage of an associated virtual object lineup configuration tactic is maximized is used. Skill biases of associated virtual object lineups required by different tactics are also different. For example, perimeter offense requires higher perimeter finish ability; interior offense requires an associated virtual object with a large height, a heavy weight, a strong body, and high interior strength; and the isolate requires an associated virtual object with high comprehensive strength to complete a finish. Therefore, in tactic selection for the associated virtual objects, a tactic that is most advantageous for the associated virtual objects is selected by default.

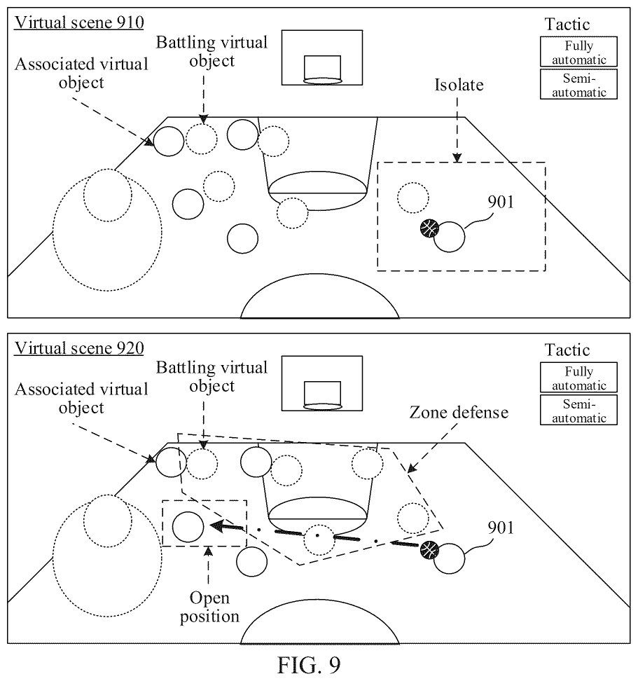

FIG. 9 is a schematic diagram of a policy using advantage information for different defenses according to an exemplary embodiment of this application. As shown in FIG. 9, a plurality of associated virtual objects include a superstar 901. Based on a current positioning layout of a plurality of battling virtual objects in a virtual scene 910, isolate is the best. However, if the battling virtual objects use zone defense, to be specific, if the plurality of battling virtual objects in the virtual scene 920 satisfy the current positioning layout, when the super superstar 901 initiates the offense, a perimeter player is open, and the ball can be passed to the perimeter player to make a finish.

By analyzing the positioning layout data and the first configuration data, a tactic is determined based on the advantage information of the associated virtual objects, so as to select a tactic mode that can maximize the advantage. Based on the understanding of the disadvantages of an offensive team, tactic execution can be performed by using the advantages to the greatest extent, to avoid an ineffective waste of resources and improving tactic execution efficiency and a battle winning rate.

(2) The first tactic mode is automatically determined based on the positioning layout data and the disadvantage information indicated by the second configuration data.

In some embodiments, the terminal determines the disadvantage information by comparing the first configuration data with the second configuration data, and determines, from the plurality of candidate tactic modes based on the positioning layout data and the disadvantage information, a tactic mode in which the battling virtual objects have maximized disadvantages as the first tactic mode.

Schematically, if battling virtual object A among the plurality of battling virtual objects is weak, for example, if battling virtual object A is shorter than matchup associated virtual object B and has a low speed and a poor defense ability, strong virtual object C (strong virtual object C may or may not be associated virtual object B) is determined from the plurality of associated virtual objects based on the disadvantage information to match up battling virtual object A. In this process, the associated virtual objects may be transposed. For example, adjacent associated virtual object D is transposed with strong virtual object C, so that strong virtual object C matches up battling virtual object A. Based on this, the first tactic mode may be determined based on the current positioning layout.

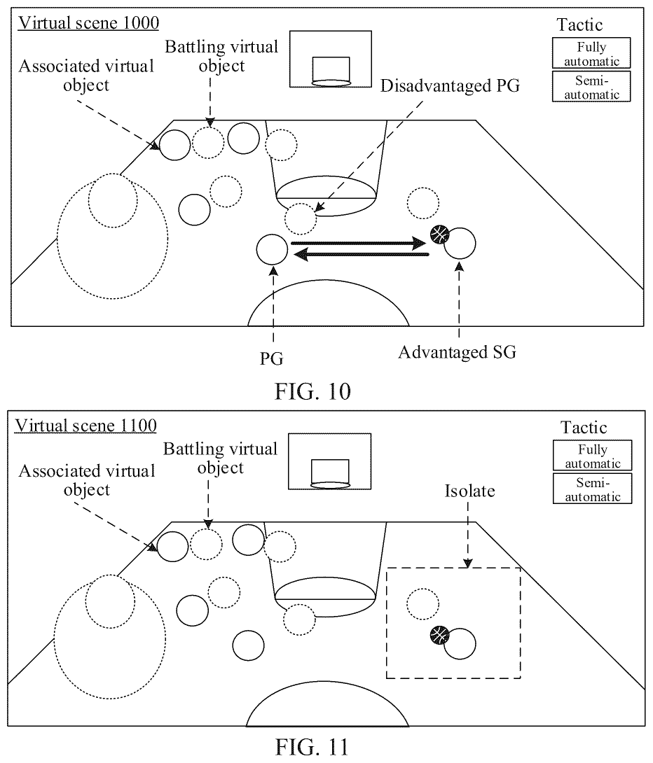

Schematically, a virtual basketball sports competition is as an example. Division is implemented based on matchup. The associated virtual objects and the battling virtual objects at least respectively include a point guard (hereinafter referred to as PG), a shooting guard (hereinafter referred to as SG), a small forward (hereinafter referred to as SF), a power forward (hereinafter referred to as PF), and a center (hereinafter referred to as C). The PG, the SG, and the SF can be transposed. The PF and the C can be transposed. Other positions cannot be transposed. FIG. 10 is a schematic diagram of a policy using disadvantage information according to an exemplary embodiment of this application. As shown in FIG. 10, a virtual scene 1000 includes a plurality of associated virtual objects and a plurality of battling virtual objects. By transposing the PG and the advantaged SG among the associated virtual objects, the advantaged SG matches up the disadvantaged PG among the matchup battling virtual objects, thereby increasing a scoring probability.

By analyzing the positioning layout data and the second configuration data, a tactic is determined based on the disadvantage information of the battling virtual objects, so as to select a tactic mode that can maximize the disadvantage. Based on the understanding of the disadvantages of the opponents, weaknesses of the opponents can be offended intensively, to avoid an ineffective waste of resources and improving tactic execution efficiency and a battle winning rate.

(3) The first tactic mode is automatically determined based on the positioning layout data and the tactic counteraction information.

In some embodiments, a counteraction relationship between the offensive tactic mode and the defensive tactic mode is used as an example. The tactic counteraction information is configured for indicating various counteraction relationships, such as a counteraction relationship between the isolate mode and the infinite switching mode, a counteraction relationship between the perimeter offense mode and the 3-2 zone defense mode, a counteraction relationship between the interior offense mode and the 2-3 zone defense mode, and a counteraction relationship between the high screen mode and the interior double-team mode.

Schematically, an example in which an isolate mode counteracts an infinite switching mode is used. FIG. 11 is a schematic diagram showing that isolate counteracts infinite switching according to an exemplary embodiment of this application. As shown in FIG. 11, a virtual scene 1100 includes a plurality of associated virtual objects and a plurality of battling virtual objects. When a positioning layout of the plurality of battling virtual objects satisfies the infinite switching mode, it may be determined, based on tactic counteraction information, that a tactic mode used by the plurality of associated virtual objects is the isolate mode.

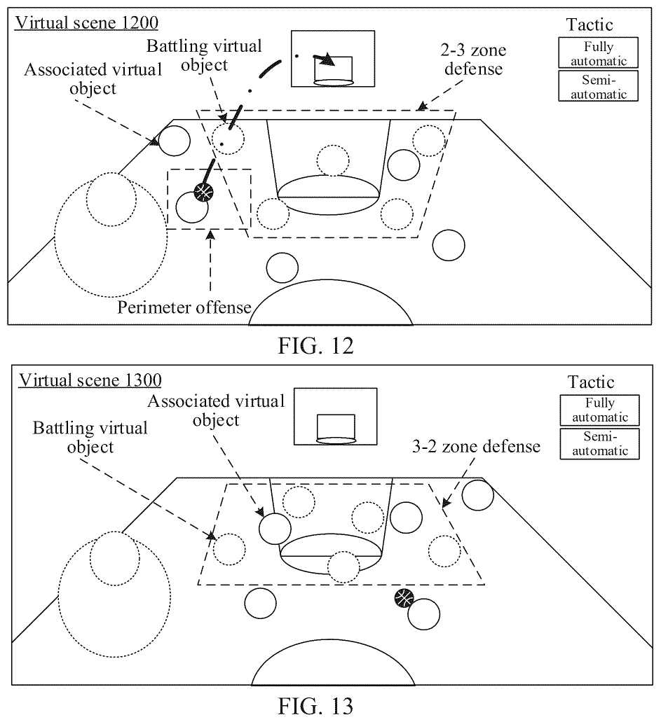

Schematically, an example in which a perimeter offense mode counteracts a 2-3 zone defense mode is used. FIG. 12 is a schematic diagram showing that perimeter offense counteracts 2-3 zone defense according to an exemplary embodiment of this application. As shown in FIG. 12, a virtual scene 1200 includes a plurality of associated virtual objects and a plurality of battling virtual objects. When a positioning layout of the plurality of battling virtual objects satisfies the 2-3 zone defense mode, it may be determined, based on tactic counteraction information, that a tactic mode used by the plurality of associated virtual objects is the perimeter offense mode.

Schematically, an example in which an interior offense mode counteracts a 3-2 zone defense mode is used. FIG. 13 is a schematic diagram showing that perimeter offense counteracts 3-2 zone defense according to an exemplary embodiment of this application. As shown in FIG. 13, a virtual scene 1300 includes a plurality of associated virtual objects and a plurality of battling virtual objects. When a positioning layout of the plurality of battling virtual objects satisfies the 3-2 zone defense mode, it may be determined, based on tactic counteraction information, that a tactic mode used by the plurality of associated virtual objects is the interior offense mode.

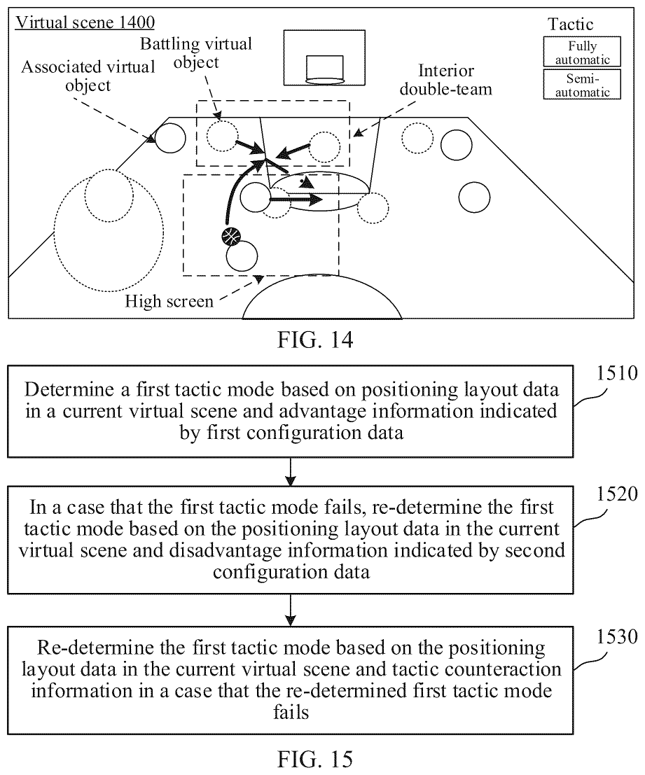

Schematically, an example in which a high screen mode counteracts an interior double-team mode is used. FIG. 14 is a schematic diagram showing that high screen counteracts interior double-team according to an exemplary embodiment of this application. As shown in FIG. 14, a virtual scene 1400 includes a plurality of associated virtual objects and a plurality of battling virtual objects. When a positioning layout of the plurality of battling virtual objects satisfies the interior double-team mode, it may be determined, based on tactic counteraction information, that a tactic mode used by the plurality of associated virtual objects is the high screen mode.

By analyzing the positioning layout data and the tactic counteraction information to determine a tactic from the perspective of counteraction of tactics, a most proper tactic mode is selected, thereby improving decision-making accuracy.

In some embodiments, determining the first tactic mode based on the positioning layout data and the tactic counteraction information is implemented in the following two operations:

In a first operation, in response to the positioning layout data being configured for indicating that a second positioning layout of the plurality of battling virtual objects satisfies a second tactic mode, a plurality of third tactic modes that counteract the second tactic mode are obtained from the plurality of candidate tactic modes based on the tactic counteraction information.

In some embodiments, a plurality of third tactic modes among the plurality of candidate tactic modes and the second tactic mode satisfy a tactic counteraction relationship.

In a second operation, in response to a first positioning layout of the plurality of associated virtual objects that is indicated by the positioning layout data satisfying a target layout rule indicated by a target tactic mode among the plurality of third tactic modes, the target tactic mode is determined as the first tactic mode.

That the first positioning layout satisfies the target layout rule includes at least one of the following cases:

first, a similarity between the first positioning layout and a positioning layout corresponding to the target layout rule reaches a preset similarity.

Schematically, image data corresponding to the first positioning layout and image data corresponding to positioning layouts respectively corresponding to the plurality of third tactic modes are obtained. A similarity between a positioning layout feature in the image data corresponding to the first positioning layout and a positioning layout feature in image data corresponding to the positioning layout corresponding to the target layout rule is calculated as the similarity between the first positioning layout and the positioning layout corresponding to the target layout rule. Alternatively, coordinates of each associated virtual object in the first positioning layout and coordinates of each positioning object in the positioning layouts respectively corresponding to the plurality of third tactic modes are obtained, and correspondence relationships between the associated virtual objects in the first positioning layout and the positioning objects in the positioning layouts corresponding to the third tactic modes are determined. For each pair of matching virtual objects (i.e. an associated virtual object in the first positioning layout and a positioning object in the positioning layouts corresponding to the third tactic modes), a coordinate difference of the pair of matching virtual objects is calculated. An average value of all the coordinate differences is calculated as a similarity measurement standard, where a larger average value indicates a lower similarity.

Second, the first positioning layout meets a tactic execution requirement of the target layout rule.

The tactic execution requirement includes duration required for changing the plurality of associated virtual objects from the first positioning layout to the positioning layout corresponding to the target layout rule being less than preset duration.

In the above embodiment, when the first positioning layout of the associated virtual objects satisfies the target layout rule of a third tactic mode (i.e. the target tactic mode), the tactic mode can be accurately determined as the first tactic mode that is currently used. The accurate matching ensures tactic execution accuracy and effectiveness.

When it is evaluated whether the first positioning layout satisfies the target layout rule, different determining bases are provided:

For a determining basis that the similarity reaches the preset similarity, by calculating the similarity between the first positioning layout and the positioning layout corresponding to the target layout rule and setting a preset similarity threshold, whether a current positioning layout is sufficiently close to a target layout can be accurately determined, thereby ensuring the tactic execution accuracy and effect.

For a determining basis that the tactic execution requirement is met, a time factor in the tactic execution requirement is considered, to ensure that the duration required for changing from the first positioning layout to the positioning layout corresponding to the target layout rule is less than the preset duration. This helps quickly adjust the positioning in an actual battle and seize the opportunity, thereby improving tactic execution efficiency and success rate.

Operation 820: Display the tactic prompt information corresponding to the first tactic mode.

For details, refer to operation 320, which will not be elaborated here.

In conclusion, according to the method provided in this embodiment of this application, the first tactic mode is determined by obtaining the current virtual battle data in the virtual scene. Intelligently selecting a tactic mode most suitable for a current situation improves tactic determining effectiveness and improving human-computer interaction efficiency.

In some embodiments, in the tactic mode determining process, namely, in operation 810 of determining the first tactic mode based on the virtual battle data, priorities of the first configuration data, the second configuration data, and the tactic counteraction information satisfy an arrangement relationship from high to low. FIG. 15 shows a flowchart of a method for determining a first tactic mode according to an exemplary embodiment of this application. The method may be performed by a terminal, or by a server, or by both a terminal and a server. This embodiment of this application is described by using an example in which the method is performed by the terminal. As shown in FIG. 15, the method includes the following operations:

Operation 1510: Determine the first tactic mode based on the positioning layout data in the current virtual scene and the advantage information indicated by the first configuration data.

In some embodiments, the advantage information is determined by comparing the first configuration data with the second configuration data, and a tactic mode in which the associated virtual objects have maximized advantages is determined as the first tactic mode from the plurality of candidate tactic modes based on the positioning layout data and the advantage information.

Operation 1520: When the first tactic mode fails, re-determine the first tactic mode based on the positioning layout data in the current virtual scene and the disadvantage information indicated by the second configuration data.

In some embodiments, the disadvantage information is determined by comparing the first configuration data with the second configuration data, and a tactic mode in which the battling virtual objects have maximized disadvantages is determined as the first tactic mode from the plurality of candidate tactic modes based on the positioning layout data and the disadvantage information.

Operation 1530: Re-determine the first tactic mode based on the positioning layout data in the current virtual scene and the tactic counteraction information when the re-determined first tactic mode fails.

In some embodiments, a counteraction relationship between the offensive tactic mode and the defensive tactic mode is used as an example. The tactic counteraction information is configured for indicating various counteraction relationships, such as a counteraction relationship between the isolate mode and the infinite switching mode, a counteraction relationship between the perimeter offense mode and the 3-2 zone defense mode, a counteraction relationship between the interior offense mode and the 2-3 zone defense mode, and a counteraction relationship between the high screen mode and the interior double-team mode.

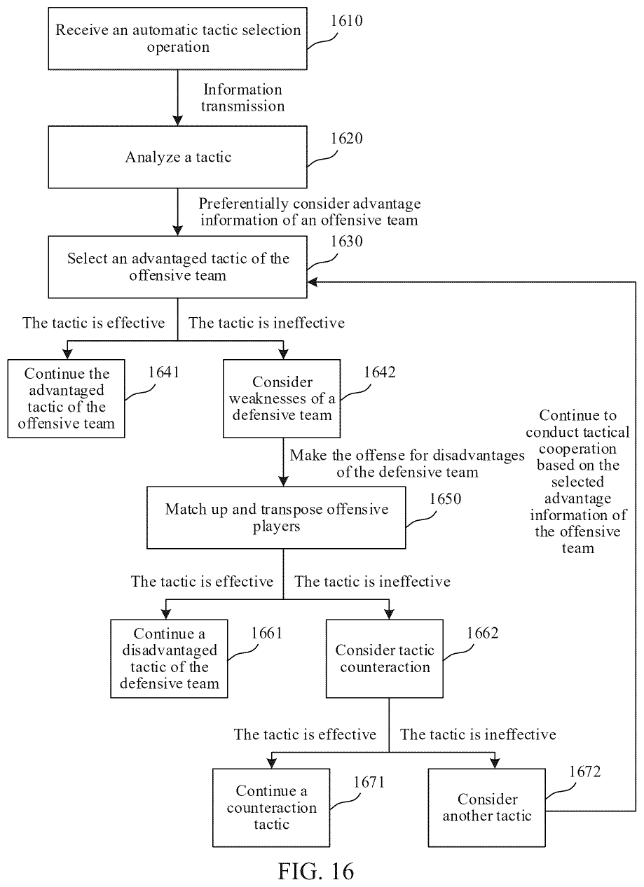

Schematically, FIG. 16 is a schematic flowchart of a method for determining tactics according to an exemplary embodiment of this application. The method may be performed by a terminal, or by a server, or by both a terminal and a server. In this embodiment of this application, an example in which the method is performed by the terminal is used for description. As shown in FIG. 16, the method for determining tactics in a virtual scene provided in this embodiment of this application includes the following operations:

Operation 1610: Receive an automatic tactic selection operation.

In some embodiments, the automatic tactic selection operation includes a fully automatic tactic selection operation and a semi-automatic tactic selection operation.

In some embodiments, after the automatic tactic selection operation is received, information transmission is performed, for example, virtual battle data is obtained, and operation 1620 is performed.

Operation 1620: Analyze a tactic.

In some embodiments, tactical analysis is performed based on the virtual battle data, to determine a first tactic mode.

Operation 1630: Select an advantaged tactic of an offensive team.

Here, the offensive team refers to a camp to which associated virtual objects belong.

In some embodiments, to improve scoring efficiency, the first tactic mode is preferentially determined based on advantage information of the associated virtual objects. In some embodiments, in response to the first tactic mode determined in operation 1630 being effective, operation 1641 is performed, and otherwise, operation 1642 is performed.

Operation 1641: Continue the advantaged tactic of the offensive team.

In some embodiments, if the first tactic mode determined in operation 1630 is effective, namely, if the first tactic mode is successfully executed, the first tactic mode continues to be determined based on advantages of the offensive team.

Operation 1642: Consider weaknesses of a defensive team.

The defensive team includes battling virtual objects.

In some embodiments, if the first tactic mode determined in operation 1630 fails, to improve the scoring efficiency, after the advantage of the offensive team is considered, the first tactic mode is preferentially determined based on disadvantage information of the battling virtual objects.

Operation 1650: Match up and transpose offensive players.

In some embodiments, by determining a disadvantaged object among the battling virtual objects, an advantaged object among the associated virtual objects matches up the disadvantaged object through transposition. In some embodiments, in response to the first tactic mode used in operation 1650 being effective, operation 1661 is performed, and otherwise, operation 1662 is performed.

Operation 1661: Continue a disadvantaged tactic of the defensive team.

In some embodiments, if the first tactic mode determined in operation 1650 is effective, namely, if the first tactic mode is successfully executed, the first tactic mode continues to be determined based on the weaknesses of the defensive team.

Operation 1662: Consider tactic counteraction.

In some embodiments, if the first tactic mode determined in operation 1650 fails, the first tactic mode is determined based on preset tactic counteraction information. In some embodiments, in response to the first tactic mode determined in operation 1662 being effective, operation 1671 is performed, and otherwise, operation 1672 is performed.

Operation 1671: Continue a counteraction tactic.

In some embodiments, if the first tactic mode determined in operation 1662 is effective, namely, if the first tactic mode is successfully executed, the first tactic mode continues to be determined based on the counteraction tactic.

Operation 1672: Consider another tactic.

In some embodiments, if the first tactic mode determined in operation 1662 fails, operation 1630 is performed, and the method for determining tactics is performed again based on order priorities of the advantages of the offensive team, the weaknesses of the defensive team, and the tactic counteraction in sequence.

In conclusion, according to the method provided in this embodiment of this application, priorities of a plurality of pieces of virtual battle data in the tactic mode determining process are clarified. Since the priorities of the first configuration data, the second configuration data, and the tactic counteraction information satisfy a descending order, the first tactic mode is preferentially determined based on the advantage situation of the associated virtual objects, so that the advantages of the offensive team can be maximized as much as possible, the scoring efficiency can be improved, and tactic determining effectiveness can be improved, thereby improving human-computer interaction efficiency.

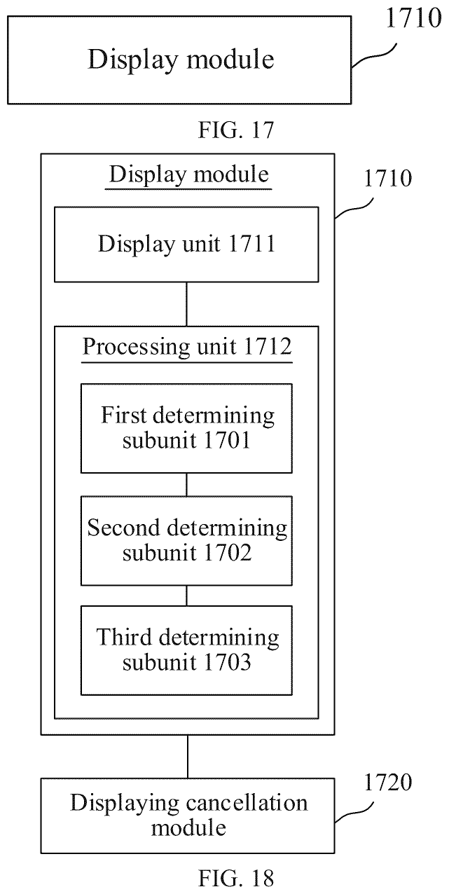

FIG. 17 is a structural block diagram of an apparatus for determining tactics in a virtual scene according to an exemplary embodiment of this application. As shown in FIG. 17, the apparatus includes the following parts:
a display module 1710, configured to display a plurality of associated virtual objects and a plurality of battling virtual objects in a virtual scene, the plurality of associated virtual objects being configured for cooperating with each other to conduct a virtual battle against the plurality of battling virtual objects;
the display module 1710 being further configured to display tactic prompt information corresponding to a first tactic mode in response to receiving an automatic tactic selection operation, the automatic tactic selection operation being configured for automatically selecting the first tactic mode from a plurality of candidate tactic modes, the tactic prompt information being configured for instructing the plurality of associated virtual objects to take positions under a layout rule of the first tactic mode and perform a reference battle action corresponding to the first tactic mode to conduct the virtual battle; and
the display module 1710 being further configured to display a tactic execution animation, the tactic execution animation including an animation in which the plurality of associated virtual objects perform the reference battle action during implementation of the first tactic mode.

Referring to FIG. 18, in some embodiments, the display module 1710 includes: a display unit 1711, configured to display, in the first tactic mode when a first virtual object among the plurality of associated virtual objects satisfies an execution condition of a first reference battle action, first tactic prompt information corresponding to the first reference battle action, the first tactic prompt information being configured for prompting the first virtual object to perform the first reference battle action.

In some embodiments, the virtual scene is a virtual scene corresponding to a ball sports competition. The display unit 1711 is configured to: display movement prompt information when the first virtual object among the plurality of associated virtual objects satisfies an execution condition of a movement action, the movement prompt information being configured for prompting the first virtual object to move toward a first position in the virtual scene; and display shooting prompt information when the first virtual object includes a ball-handling virtual object and the ball-handling virtual object satisfies an execution condition of a shooting action, the shooting prompt information being configured for prompting the ball-handling virtual object to throw a virtual ball prop toward a shooting target, and the shooting target including a virtual ball hoop or another virtual object.

In some embodiments, the display module 1710 is configured to automatically display the tactic execution animation when a fully automatic tactic selection operation is received, the fully automatic tactic selection operation being configured for: automatically determining the first tactic mode and controlling the plurality of associated virtual objects to automatically perform the reference battle action.

In some embodiments, the display module 1710 is configured to display when a semi-automatic tactic selection operation is received, the tactic execution animation in response to receiving a tactic execution operation on the plurality of associated virtual objects, the semi-automatic tactic selection operation being configured for: automatically determining the first tactic mode and performing the reference battle action in response to the tactic execution operation.

In some embodiments, a first account logs in to the computer device. The display module 1710 is configured to: display a first control when the first account does not meet a proficiency requirement, the first control being configured for triggering the fully automatic tactic selection operation; and display the first control and a second control when the first account meets the proficiency requirement, the second control being configured for triggering the semi-automatic tactic selection operation.

In some embodiments, the apparatus further includes a displaying cancellation module 1720, configured to cancel displaying a first tactic layout result and the tactic execution animation in response to a failure of the first tactic mode.

In some embodiments, the virtual scene is a virtual scene corresponding to a ball sports competition. The failure of the first tactic mode includes at least one of the following cases: execution of the first tactic mode is completed; a virtual object waiting for movement does not move based on the movement prompt information during movement; and when the ball-handling virtual object throws the virtual ball prop toward the shooting target, the ball-handling virtual object fails in throwing.

In some embodiments, the display module 1710 includes: a processing unit 1712, configured to determine the first tactic mode based on virtual battle data in a current virtual scene when the automatic tactic selection operation is received, the virtual battle data including positioning layout data, and the positioning layout data being configured for indicating a positioning layout of the associated virtual objects and the battling virtual objects in the virtual scene. The display unit 1711 is configured to display the tactic prompt information corresponding to the first tactic mode.

In some embodiments, the processing unit 1712 includes: a first determining subunit 1701, configured to determine the first tactic mode based on the positioning layout data in the current virtual scene and advantage information indicated by first configuration data, the first configuration data being configured for indicating a battling ability of the associated virtual objects in the virtual battle.

In some embodiments, the processing unit 1712 includes: a second determining subunit 1702, configured to determine the first tactic mode based on the positioning layout data in the current virtual scene and disadvantage information indicated by second configuration data, the second configuration data being configured for indicating a battling ability of the battling virtual objects in the virtual battle.

In some embodiments, the processing unit 1712 includes: a third determining subunit 1703, configured to determine the first tactic mode based on the positioning layout data in the current virtual scene and tactic counteraction information, the tactic counteraction information being configured for indicating counteraction relationships between the plurality of candidate tactic modes.

In some embodiments, the third determining subunit 1703 is configured to: in response to the positioning layout data being configured for indicating that a second positioning layout of the plurality of battling virtual objects satisfies a second layout rule indicated by a second tactic mode, obtain, from the plurality of candidate tactic modes based on the tactic counteraction information, a plurality of third tactic modes that counteract the second tactic mode; and in response to a first positioning layout of the plurality of associated virtual objects that is indicated by the positioning layout data satisfying a target layout rule indicated by a target tactic mode among the plurality of third tactic modes, determine the target tactic mode as the first tactic mode.

In some embodiments, that the first positioning layout satisfies the target layout rule includes at least one of the following cases: a similarity between the first positioning layout and a positioning layout corresponding to the target layout rule reaches a preset similarity; and the first positioning layout meets a tactic execution requirement of the target layout rule, the tactic execution requirement including duration required for changing the plurality of associated virtual objects from the first positioning layout to the positioning layout corresponding to the target layout rule being less than preset duration.

In some embodiments, the processing unit 1712 is configured to determine the first tactic mode based on the positioning layout data in the current virtual scene and the advantage information indicated by the first configuration data; when the first tactic mode fails, re-determine the first tactic mode based on the positioning layout data in the current virtual scene and the disadvantage information indicated by the second configuration data; and re-determine the first tactic mode based on the positioning layout data in the current virtual scene and the tactic counteraction information when the re-determined first tactic mode fails.

The apparatus for determining the tactics in the virtual scene provided in the above embodiments is only illustrated by division of the above functional modules. In practical application, allocation of the foregoing functions may be completed by different functional modules as required, namely, an inner structure of a device is divided into different functional modules, so as to complete all or some of the functions described above.

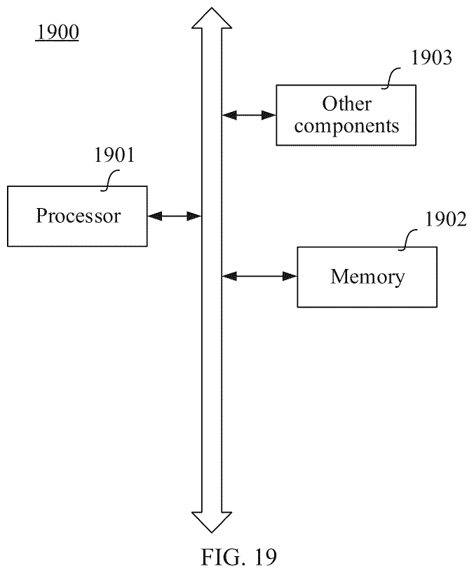

FIG. 19 is a structural block diagram of a terminal 1900 according to an exemplary embodiment of this application. The terminal 1900 may be: a smartphone, a tablet computer, an MP3 player, an MP4 player, a notebook computer, or a desktop computer. The terminal 1900 may also be referred to as another name such as user equipment, a portable terminal, a laptop terminal, or a desktop terminal.

Generally, the terminal 1900 includes a processor 1901 and a memory 1902.

The processor 1901 may include one or more processing cores, for example, a 4-core processor or an 8-core processor. The processor 1901 may be implemented in at least one hardware form of a digital signal processor (DSP), a field-programmable gate array (FPGA), and a programmable logic array (PLA). The processor 1901 may further include a main processor and a coprocessor. The main processor is a processor configured to process data in an awake state, and is also referred to as a central processing unit (CPU). The coprocessor is a low-power processor configured to process data in a standby state. In some embodiments, the processor 1901 may be integrated with a graphics processing unit (GPU). The GPU is configured to render and draw content that needs to be displayed on a display screen. In some embodiments, the processor 1901 may further include an artificial intelligence (AI) processor. The AI processor is configured to process computing operations related to machine learning.

The memory 1902 may include one or more computer-readable storage media. The computer-readable storage media may be non-transient. The memory 1902 may further include a high-speed random access memory and a nonvolatile memory, for example, one or more disk storage devices or flash storage devices. In some embodiments, the non-transient computer-readable storage medium in the memory 1902 is configured to store at least one instruction, and the at least one instruction is configured for being executed by the processor 1901 to perform the method for determining the tactics in the virtual scene, which is provided in the method embodiments of this application.

In some embodiments, the terminal 1900 further includes some other components 1903. A type and quantity of other components 1903 may be selected based on functions of the terminal 1900. A person skilled in the art may understand that the structure shown in FIG. 19 does not constitute a limitation to the terminal 1900, and the terminal 1900 may include more or fewer components than those shown in the figure, or some components may be combined, or a different component deployment may be used.

An embodiment of this application further provides a computer device. The computer device may be implemented as the terminal or the server shown in FIG. 1. The computer device includes a processor and a memory. The memory has at least one instruction, at least one program, a code set, or an instruction set stored therein. The at least one instruction, the at least one program, the code set, or the instruction set is loaded and executed by the processor to implement the method for determining the tactics in the virtual scene, which is provided in the above method embodiments. An embodiment of this application further provides a non-transitory computer-readable storage medium, having at least one instruction, at least one program, a code set, or an instruction set stored therein. The at least one instruction, the at least one program, the code set, or the instruction set is loaded and executed by a processor to implement the method for determining the tactics in the virtual scene, which is provided in the above method embodiments. An embodiment of this application further provides a computer program product or a computer program, including a computer instruction. The computer instruction is stored in a non-transitory computer-readable storage medium. A processor of a computer device reads the computer instruction from the computer-readable storage medium and executes the computer instruction, causing the computer device to perform the method for determining the tactics in the virtual scene, which is provided in the above method embodiments. In some embodiments, the computer-readable storage medium may include: a read only memory (ROM), a random access memory (RAM), a solid state drive (SSD), an optical disc, or the like. The RAM may include a resistance random access memory (ReRAM) and a dynamic random access memory (DRAM). The sequential numbers of the foregoing embodiments of this application are merely for description purpose but do not imply the preference of the embodiments.

A person of ordinary skill in the art may understand that all or some of the operations of the foregoing embodiments may be implemented by hardware, or may be implemented by a program instructing relevant hardware. The program may be stored in a non-transitory computer-readable storage medium. The storage medium mentioned above may be a ROM, a magnetic disk, an optical disc, or the like. The foregoing descriptions are merely some embodiments of this application, but are not intended to limit this application. Any modification, equivalent replacement, or improvement made within the spirit and principle of this application shall fall within the protection scope of this application. In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. A method for determining tactics in a virtual scene performed by a computer device, the method comprising:
displaying a plurality of associated virtual objects and a plurality of battling virtual objects in a virtual scene, the plurality of associated virtual objects being configured for cooperating with each other to conduct a virtual battle against the plurality of battling virtual objects;
automatically selecting a first tactic mode from a plurality of candidate tactic modes in response to receiving an automatic tactic selection operation by a user of the computer device;
displaying tactic prompt information corresponding to the first tactic mode, the tactic prompt information being configured for prompting the plurality of associated virtual objects to perform a reference battle action corresponding to the first tactic mode based on a layout rule indicating positioning of the plurality of associated virtual objects in the virtual scene associated with the first tactic mode; and
generating a tactic execution animation, the tactic execution animation comprising an animation in which the plurality of associated virtual objects perform the reference battle action.

2. The method according to claim 1, wherein the displaying tactic prompt information corresponding to a first tactic mode comprises:
displaying, when a first virtual object among the plurality of associated virtual objects satisfies an execution condition of a first reference battle action, first tactic prompt information corresponding to the first reference battle action, the first tactic prompt information being configured for prompting the first virtual object to perform the first reference battle action.

3. The method according to claim 2, wherein the virtual scene is a virtual scene corresponding to a ball sports competition;
the displaying, when a first virtual object among the plurality of associated virtual objects satisfies an execution condition of a first reference battle action, first tactic prompt information corresponding to the first reference battle action comprises:
displaying movement prompt information when the first virtual object among the plurality of associated virtual objects satisfies an execution condition of a movement action, the movement prompt information being configured for prompting the first virtual object to move toward a first position in the virtual scene; and
displaying shooting prompt information when the first virtual object comprises a ball-handling virtual object and the ball-handling virtual object satisfies an execution condition of a shooting action, the shooting prompt information being configured for prompting the ball-handling virtual object to throw a virtual ball prop toward a shooting target, and the shooting target comprising a virtual ball hoop or another virtual object.

4. The method according to claim 1, wherein the displaying a tactic execution animation comprises:
automatically displaying the tactic execution animation when a fully automatic tactic selection operation is received, the fully automatic tactic selection operation being configured for: automatically determining the first tactic mode and controlling the plurality of associated virtual objects to automatically perform the reference battle action.

5. The method according to claim 1, wherein the displaying a tactic execution animation comprises:
displaying, when a semi-automatic tactic selection operation is received, the tactic execution animation in response to receiving a tactic execution operation on the plurality of associated virtual objects, the semi-automatic tactic selection operation being configured for: automatically determining the first tactic mode and performing the reference battle action in response to the tactic execution operation.

6. The method according to claim 1, wherein the method further comprises:
displaying a first control when a first account associated with the user of the computer device does not meet a proficiency requirement, the first control being configured for triggering the fully automatic tactic selection operation; and
displaying the first control and a second control when the first account meets the proficiency requirement, the second control being configured for triggering the semi-automatic tactic selection operation.

7. The method according to claim 1, wherein, after the displaying a tactic execution animation, the method further comprises:
canceling displaying the tactic prompt information and the tactic execution animation in response to a failure of the first tactic mode.

8. The method according to claim 1, wherein the virtual scene is the virtual scene corresponding to a ball sports competition;
a failure of the first tactic mode comprises at least one of the following cases:
execution of the first tactic mode is completed;
a virtual object waiting for movement does not move based on the movement prompt information during movement; and
when the ball-handling virtual object throws the virtual ball prop toward the shooting target, the ball-handling virtual object fails in throwing.

9. The method according to claim 1, wherein the displaying tactic prompt information corresponding to the first tactic mode comprises:
determining the first tactic mode based on virtual battle data in a current virtual scene when the automatic tactic selection operation is received, the virtual battle data comprising positioning layout data, and the positioning layout data being configured for indicating a positioning layout of the associated virtual objects and the battling virtual objects in the virtual scene; and
displaying the tactic prompt information corresponding to the first tactic mode.

10. The method according to claim 1, wherein the automatically selecting the first tactic mode from the plurality of candidate tactic modes comprises:
determining the first tactic mode based on the positioning layout data in the current virtual scene and advantage information indicated by first configuration data, the first configuration data being configured for indicating a battling ability of the associated virtual objects in the virtual battle.

11. The method according to claim 1, wherein the automatically selecting the first tactic mode from the plurality of candidate tactic modes comprises:
determining the first tactic mode based on the positioning layout data in the current virtual scene and disadvantage information indicated by second configuration data, the second configuration data being configured for indicating a battling ability of the battling virtual objects in the virtual battle.

12. The method according to claim 1, wherein the automatically selecting the first tactic mode from the plurality of candidate tactic modes comprises:
determining the first tactic mode based on the positioning layout data in the current virtual scene and tactic counteraction information, the tactic counteraction information being configured for indicating counteraction relationships between the plurality of candidate tactic modes.

13. The method according to claim 1, wherein the automatically selecting the first tactic mode from the plurality of candidate tactic modes comprises:
in response to the positioning layout data being configured for indicating that a second positioning layout of the plurality of battling virtual objects satisfies a second layout rule indicated by a second tactic mode, obtaining, from the plurality of candidate tactic modes based on the tactic counteraction information, a plurality of third tactic modes that counteract the second tactic mode; and
in response to a first positioning layout of the plurality of associated virtual objects that is indicated by the positioning layout data satisfying a target layout rule indicated by a target tactic mode among the plurality of third tactic modes, determining the target tactic mode as the first tactic mode.

14. The method according to claim 1, wherein that the first positioning layout satisfies the target layout rule comprises at least one of the following cases:
a similarity between the first positioning layout and a positioning layout corresponding to the target layout rule reaches a preset similarity; and
the first positioning layout meets a tactic execution requirement of the target layout rule, the tactic execution requirement comprising duration required for changing the plurality of associated virtual objects from the first positioning layout to the positioning layout corresponding to the target layout rule being less than preset duration.

15. The method according to claim 1, wherein the automatically selecting the first tactic mode from the plurality of candidate tactic modes comprises:
determining the first tactic mode based on the positioning layout data in the current virtual scene and the advantage information indicated by the first configuration data;
when the first tactic mode fails, re-determining the first tactic mode based on the positioning layout data in the current virtual scene and the disadvantage information indicated by the second configuration data; and
re-determining the first tactic mode based on the positioning layout data in the current virtual scene and the tactic counteraction information when the re-determined first tactic mode fails.

16. A computer device, comprising a processor and a memory, the memory having at least one computer program stored therein, the at least one computer program, when being loaded and executed by the processor, causing the computer device to implement a method for determining tactics in a virtual scene including:
displaying a plurality of associated virtual objects and a plurality of battling virtual objects in a virtual scene, the plurality of associated virtual objects being configured for cooperating with each other to conduct a virtual battle against the plurality of battling virtual objects;
automatically selecting a first tactic mode from a plurality of candidate tactic modes in response to receiving an automatic tactic selection operation by a user of the computer device;
displaying tactic prompt information corresponding to the first tactic mode, the tactic prompt information being configured for prompting the plurality of associated virtual objects to perform a reference battle action corresponding to the first tactic mode based on a layout rule indicating positioning of the plurality of associated virtual objects in the virtual scene associated with the first tactic mode; and
generating a tactic execution animation, the tactic execution animation comprising an animation in which the plurality of associated virtual objects perform the reference battle action.

17. The computer device according to claim 16, wherein the displaying tactic prompt information corresponding to a first tactic mode comprises:
displaying, when a first virtual object among the plurality of associated virtual objects satisfies an execution condition of a first reference battle action, first tactic prompt information corresponding to the first reference battle action, the first tactic prompt information being configured for prompting the first virtual object to perform the first reference battle action.

18. The computer device according to claim 16, wherein the displaying a tactic execution animation comprises:
automatically displaying the tactic execution animation when a fully automatic tactic selection operation is received, the fully automatic tactic selection operation being configured for: automatically determining the first tactic mode and controlling the plurality of associated virtual objects to automatically perform the reference battle action.

19. The computer device according to claim 16, wherein the method further comprises:
displaying a first control when a first account associated with the user of the computer device does not meet a proficiency requirement, the first control being configured for triggering the fully automatic tactic selection operation; and
displaying the first control and a second control when the first account meets the proficiency requirement, the second control being configured for triggering the semi-automatic tactic selection operation.

20. A non-transitory computer-readable storage medium, having at least one computer program stored therein, the at least one computer program, when being loaded and executed by a processor of a computer device, causing the computer device to implement a method for determining tactics in a virtual scene including:
displaying a plurality of associated virtual objects and a plurality of battling virtual objects in a virtual scene, the plurality of associated virtual objects being configured for cooperating with each other to conduct a virtual battle against the plurality of battling virtual objects;
automatically selecting a first tactic mode from a plurality of candidate tactic modes in response to receiving an automatic tactic selection operation by a user of the computer device;
displaying tactic prompt information corresponding to the first tactic mode, the tactic prompt information being configured for prompting the plurality of associated virtual objects to perform a reference battle action corresponding to the first tactic mode based on a layout rule indicating positioning of the plurality of associated virtual objects in the virtual scene associated with the first tactic mode; and
generating a tactic execution animation, the tactic execution animation comprising an animation in which the plurality of associated virtual objects perform the reference battle action.
